(19) United States
(12) Patent Application Publication
(10) Pub. No.: US 2026/0027703 A1
(43) Pub. Date: Jan. 29, 2026

(54) METHODS AND SYSTEMS FOR ROBOT LEARNING AND CONTROLLING A ROBOT

(71) Applicant: COLLABORATIVE ROBOTICS, Santa Clara, CA (US)

(72) Inventors: Brandon Porter, Santa Clara, CA (US); Michael Vogelsong, Santa Clara, CA (US)

(21) Appl. No.: 19/281,416

(22) Filed: Jul. 25, 2025

Related U.S. Application Data
(60) Provisional application No. 63/676,171, filed on Jul. 26, 2024.

(51) Int. Cl. B25J 9/16

(52) U.S. Cl. CPC B25J 9/161; B25J 9/1656; G05B 2219/39001

(57) ABSTRACT

One or more embodiments of the present disclosure may include a method. The method may include receiving an instruction identifying an operation to be completed by a robot. The method may also include identifying, using an artificial intelligence (AI) model, a task to be performed by the robot to complete the operation. Additionally, the method may include identifying, using the AI model, a series of movements to be made by the robot to perform the task. Further, the method may include identifying, using the AI model, a series of raw electrical signals configured to cause actuators to move the robot in accordance with the series of movements. The method may include generating the series of raw electrical signals to cause the actuators to move the robot in accordance with the series of movements and cause the robot to perform the task.

### CROSS-REFERENCE TO RELATED APPLICATION

This patent application claims the benefit of and priority to U.S. Provisional App. No. 63/676,171 filed Jul. 26, 2024, titled “METHODS FOR ROBOT LEARNING,” which is incorporated in the present disclosure by reference in its entirety.

### FIELD

The embodiments discussed in the present disclosure are related to methods and systems for robot learning and controlling a robot.

### BACKGROUND

Unless otherwise indicated in the present disclosure, the materials described in the present disclosure are not prior art to the claims in the present application and are not admitted to be prior art by inclusion in this section.

Robots have been used in recent years to perform operations in various facilities including manufacturing, warehouses, logistics, and delivery settings. Robots have been useful in making operations more efficient, thereby improving efficiency and lowering costs to operate the facilities.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a method. The method may include receiving an instruction identifying an operation to be completed by a robot. The method may also include identifying, using an artificial intelligence (AI) model, a task to be performed by the robot to complete the operation. Additionally, the method may include identifying, using the AI model, a series of movements to be made by the robot to perform the task. Further, the method may include identifying, using the AI model, a series of raw electrical signals configured to cause actuators to move the robot in accordance with the series of movements. The method may include generating the series of raw electrical signals to cause the actuators to move the robot in accordance with the series of movements and cause the robot to perform the task.

One or more embodiments of the present disclosure may include a system. The system may include one or more computer readable media configured to store instructions. The system may also include a processor coupled to the computer readable media. The processor may be configured to execute the instructions to cause or direct the system to perform operations. The operations may include receiving an instruction identifying an operation to be completed by a robot. The operations may also include identifying, using an AI model, a task to be performed by the robot to complete the operation. Additionally, the operations may include identifying, using the AI model, a series of movements to be made by the robot to perform the task. Further, the operations may include identifying, using the AI model, a series of raw electrical signals configured to cause actuators to move the robot in accordance with the series of movements. The operations may include generating the series of raw electrical signals to cause the actuators to move the robot in accordance with the series of movements and cause the robot to perform the task.

One or more embodiments of the present disclosure may include a system. The system may include one or more computer readable media configured to store instructions. The system may also include a processor coupled to the computer readable media. The processor may be configured to execute the instructions to cause or direct the system to perform operations. The operations may include monitoring a plurality of raw electrical signals that are sent to an actuator of a robot. The plurality of raw electrical signals may be configured to activate the actuator to cause the robot to move. The operations may also include identifying a task for the robot that corresponds to the plurality of raw electrical signals. Additionally, the operations may include predicting a signal waveform of each raw electrical signal of the plurality of raw electrical signals and a portion of the task for the robot that corresponds to each signal waveform. Further, the operations may include generating training data indicating the task for the robot that corresponds to the plurality of raw electrical signals and the portion of the task for the robot that corresponds to each signal waveform.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment in which an autonomous robot may operate;

FIGS. 2A-2D illustrate a sequence of views of examples of the arm and the effector of the autonomous robot of FIG. 1 moving to grasp an object;

FIG. 3 illustrates an example flowchart of an example method to generate raw electrical signals to cause a robot to move, and

FIG. 4 illustrates an example computing system that may be used for identifying, generating, or both raw electrical signals for an autonomous robot,

all according to at least one embodiment described in the present disclosure.

### DETAILED DESCRIPTION

A robot may be configured to perform tasks within an environment to complete operations. The robot may receive an instruction identifying an operation that is to be completed by the robot. The robot may receive the instruction from a server (e.g., via a network) or from an operator within the environment. The robot may generate raw electrical signals to activate actuators and move the robot to perform one or more tasks to complete the operation. For example, the raw electrical signals may activate the actuators and move an appendage of the robot to interface with an object in the environment. As another example, the raw electrical signals may activate the actuators and drive wheels and control a suspension system of the robot to navigate the robot within the environment. As used in the present disclosure, movement of the robot or moving the robot may include moving one or more parts of the robot, driving one or more parts of the robot to move the entire robot, controlling one or more parts of the robot to control the robot, or some combination thereof. In some embodiments, the raw electrical signals may include a pulse width modulation signal, a frequency signal, a voltage signal, a current signal, or any other appropriate signal.

For some robot technologies, the instruction may identify tasks, the raw electrical signals that are to be generated to perform the tasks, or both. Accordingly, some robots may generate the raw electrical signals based on the instruction. However, the instruction may not always identify the tasks, the raw electrical signals that are to be generated to perform the tasks, or both.

Accordingly, some robots may not be able to generate the raw electrical signals based on the instruction. To generate the raw electrical signals, these robots may send a request to the server to identify the raw electrical signals that are to be generated to perform the tasks. Therefore, by sending the request to the server, these robots may cause a delay before starting the tasks and completing the operation. A length of the delay may be equal to an amount of time to send the request to and receive a response from the server.

Additionally, the raw electrical signals may correspond to high level tasks for the robot. These raw electrical signals may cause the robots to make coarse movements (e.g., large-scale movements with lower precision) to perform the tasks. Accordingly, these robots may perform the tasks with lower precision, which may cause the robots to be less dexterous, adaptable, or responsive. Therefore, these robots may perform the tasks with a low or reduced success rate.

Thus, there is a need for a robot that can identify the raw electrical signals to be generated based on the instruction to prevent a delay from being introduced or to generate the raw electrical signals that cause the robot to make fine movements to perform the tasks and complete the operation.

A robot in accordance with embodiments described in the present disclosure may identify the raw electrical signals based on the instruction. According to at least one embodiment, a computing device of the robot may receive an instruction identifying an operation to be completed by the robot. The computing device may also identify using an AI model, a task to be performed by the robot to complete the operation. Additionally, the computing device may identify, using the AI model, a series of movements to be made by the robot to perform the task. Further, the computing device may identify, using the AI model, a series of raw electrical signals configured to cause actuators to move the robot in accordance with the series of movements. The computing device may generate the series of raw electrical signals or cause the raw electrical signals to be generated to cause the actuators to move the robot in accordance with the series of movements and cause the robot to perform the task.

As described briefly above and in more detail below, the computing device of the robot described in the present disclosure can identify the raw electrical signals to be generated based on the instruction to prevent delays from being introduced to performing the tasks and completing the operation. For example, the computing device may identify the raw electrical signals to be generated to avoid sending requests to the server. Additionally or alternatively, the computing device may identify raw electrical signals that result in fine movements by the robot to perform the tasks. Accordingly, the computing device may cause movements of the robot to be more accurate or the robot to be more dexterous adaptable, or responsive. Therefore, the robot may perform the tasks with a high or increased success rate. Accordingly, the robot described in the present disclosure provides improvements to the technical field of robotics, autonomous operation of robots, or both.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

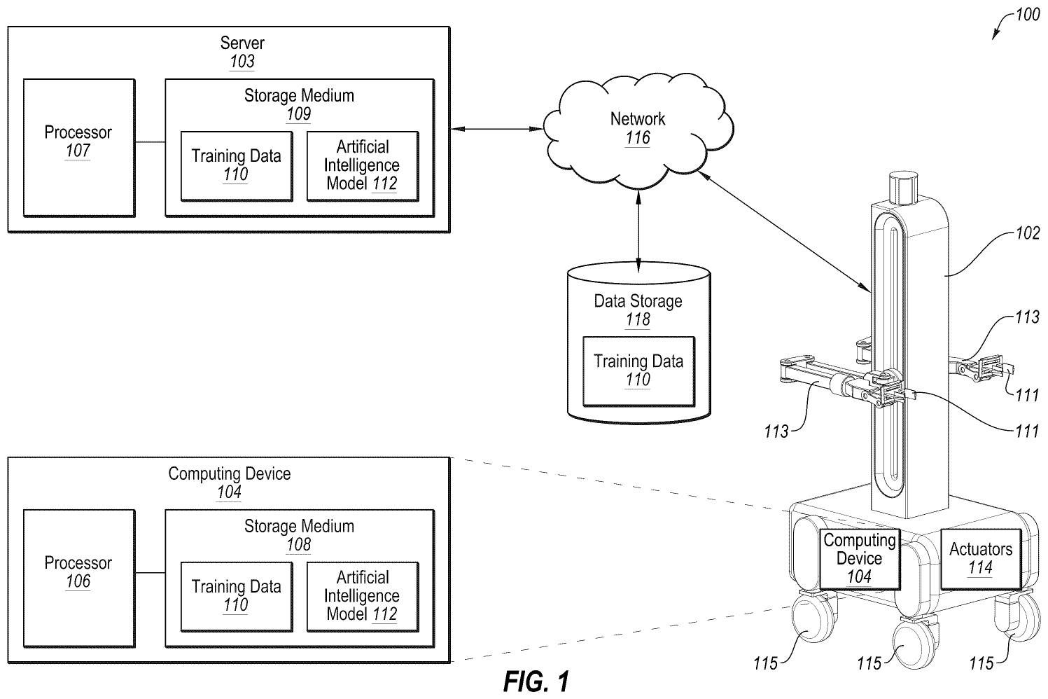

FIG. 1 illustrates a block diagram of an example operational environment 100 in which an autonomous robot 102 (generally referred to in the present disclosure as robot 102) may operate, in accordance with at least one embodiment described in the present disclosure. The environment 100 may include any location in which the robot 102 may operate. For example, the environment 100 may include a warehouse, a hospital, a campus, a building, a field, a construction site, and the like. The environment 100 includes a server 103, a data storage 118, a network 116, and the robot 102.

The computing device 104 may obtain the AI model 112 from the data storage 118, the server 103, or both via the network 116. Examples of the AI model 112 include, but are not limited to a transformer neural network, a large language model, a logic model, a rule-based model (e.g., if-then rules), a decision tree model, a convolutional neural network model, a linear regression model, a logistic regression model, a supervised learning model, an unsupervised learning model, a deep learning model, a machine learning model, any other appropriate AI model, or some combination thereof.

The robot 102 may receive an instruction from the server 103, an operator (not shown), or both. For example, the robot 102 may receive an instruction such as “carry the box to the storage room.” The instruction may identify an operation (e.g., carrying the box to the storage room) to be completed by the robot 102 within the environment 100. In some embodiments, the instruction may indicate that the operation is to be completed based on an event occurring in the environment 100.

In some embodiments, the instruction may identify tasks to be performed by the robot 102 to complete the operation. In other embodiments, the computing device 104 may execute an AI model 112 to identify the tasks to be performed to complete the operation based on the instruction (e.g., the instruction may not identify the tasks). For example, the AI model 112 may identify a series of tasks including locating the box, grasping the box, navigating to the storage room, and placing the box in the storage room based on the instruction. As another example, the AI model 112 may identify a finer series of tasks including locating the box, navigating the robot 102 proximate to the box, moving an arm 113 closer to the box, opening an effector 111 of the robot 102, moving the arm 113 to position the box within the effector 111, closing the effector 111 on the box, lifting the arm 113, navigating to the storage room, and placing the box in the storage room. The AI model 112 may identify the tasks by analyzing the instruction.

The computing device 104 may execute the AI model 112 to identify a series of movements to be made by the robot 102 to perform the tasks. The AI model 112 may identify the series of movements based on the identified tasks. In some embodiments, the AI model 112 may identify coarse movements of the robot 102, fine movements of the robot 102, or both that are to be made to perform the tasks. For example, the AI model 112 may identify a series of fine movements to be made by the robot 102, a series of coarse movements to be made by the robot 102, or both. In these embodiments, the AI model 112 may arrange the movements in different stages such as an initial coarse stage, a secondary coarse stage, a fine stage, or any other appropriate stage or number of stages based on the corresponding types of movements (e.g., if it is a fine movement or a coarse movement).

The coarse movements of the robot 102 may include relatively large-scale movements (e.g., coarse movements of the corresponding part or of the robot 102 itself) with lower precision compared to the fine movements of the robot 102. The coarse movements may be used for larger positioning tasks for which precise positioning may not be needed. For example, the coarse movements may be used for initial movements of the robot 102 towards an object, initial or general orientation movements of the robot 102, or causing the robot 102 to traverse relatively large distances within the environment 100. The coarse movements may be measured in centimeters or greater units (e.g., meters) or may include movements across a significant portion of a range of motion of a part. For example, the coarse movements may include moving the arm 113 one meter or driving wheels 115 of the robot 102 to move the robot 102 ten meters within the environment 100.

The fine movements of the robot 102 may include relatively small-scale movements (e.g., fine movements of the corresponding part or of the robot 102 itself) with greater precision compared to the coarse movements. The fine movements may be used for smaller positioning tasks for which precise positioning may be needed. For example, the fine movements may be used for grasping an object, placing an object at a specific location, causing the robot 102 to move small distances, or making small incremental adjustments to maintain balance of the robot 102 during operation. The fine movements may be measured in millimeters (mm) or smaller units or include movements across a smaller portion of the range of motion of the part. For example, the fine movements may include moving the effector 111 two mm to grasp an object, moving the arm 113 exactly ninety three mm, or driving the wheels 115 to move the robot 102 in increments of three mm to position the robot 102 close to an item (e.g., an obstacle, a shelf, a counter, or any other appropriate item) in the environment 100.

The computing device 104 may execute the AI model 112 to predict or identify a series of raw electrical signals to provide to actuators 114 of the robot 102 to cause the robot 102 to move (e.g., one or more parts of the robot 102 or the robot 102 itself) in accordance with the series of movements. The AI model 112 may predict or identify the series of raw electrical signals based on the identified series of movements. The AI model 112 may combine the raw electrical signals into different groups that correspond to different stages of the movements. For example, the AI model 112 may combine the raw electrical signals into groups that correspond to a coarse stage, a fine stage, or any other appropriate stage. The raw electrical signals may be combined based on whether they cause the coarse movements or the fine movements of the robot 102.

The raw electrical signals that cause the coarse movements may be characterized by simplified waveforms including fewer modulation parameters compared to the raw electrical signals that cause the fine movements. The coarse movements may occur due to the raw electrical signals including larger amplitudes, duration values, or both compared to the raw electrical signals that cause the fine movements. The larger amplitudes, duration values, or both of the raw electrical signals may result in the actuators 114 causing larger displacement of the robot 102 per raw electrical signal. The raw electrical signals may cause the coarse movements due to the raw electrical signals being sent at a frequency (e.g., a rate of providing the raw electrical signals, a signal frequency, or both) that is less than a threshold value (e.g., less than ten raw electrical signals per second). The raw electrical signals being sent at a lower frequency may cause the robot 102 to move large distances due to an amount of time between the raw electrical signals being greater than the amount of time between the raw electrical signals that cause the fine movements. Accordingly, the raw electrical signals that cause the coarse movements may be due to factors external to the raw electrical signals themselves (e.g., external to the waveforms).

The raw electrical signals that cause the fine movements may be characterized by complex waveforms including more modulation parameters compared to the raw electrical signals that cause the coarse movements. The fine movements may occur due to the raw electrical signals including smaller amplitudes, duration values, or both compared to the raw electrical signals that cause the coarse movements. The smaller amplitudes, duration values, or both of the raw electrical signals may result in the actuators 114 causing smaller displacement of the robot 102 per raw electrical signal. The raw electrical signals may cause the fine movements due to the raw electrical signals being sent at a frequency (e.g., a rate of providing the raw electrical signals, a signal frequency, or both) that is equal to or greater than the threshold value (e.g., equal to or greater than ten raw electrical signals per second). The raw electrical signals being sent at a higher frequency may cause the robot 102 to move small distances due to the amount of time between the raw electrical signals being less than the amount of time between the raw electrical signals that cause the coarse movements. Accordingly, the raw electrical signals that cause the fine movements may be due to factors external to the raw electrical signals themselves (e.g., external to the waveforms).

The robot 102, the computing device 104, or both may generate the series of raw electrical signals or cause the series of raw electrical signals to be generated. The generated raw electrical signals may activate the actuators 114 to cause the robot 102 to move in accordance with the series of movements and perform the tasks and complete the operation. For example, the raw electrical signals may be generated at a rate that is less than the threshold value to cause the series of coarse movements to be made during a first period of time and at a rate that is equal to or greater than the threshold value to cause the series of fine movements to be made during a second period of time.

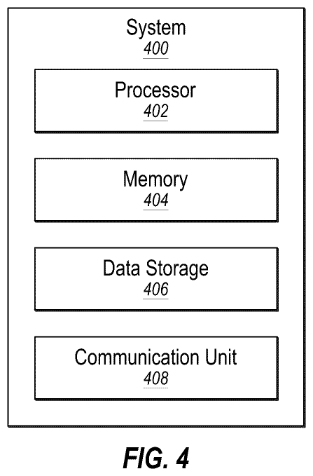

The computing device 104 may include a desktop computer, a laptop computer, a smartphone, a mobile phone, a tablet computer, a server, a processing system, or any other computing system or set of computing systems that may be used for performing the operations described in this disclosure. An example of such a computing system is described below with reference to FIG. 4. The computing device 104 may include a processor 106 and a storage medium 108 that host the AI model 112 or store training data 110.

The server 103 may be a computer system that provides services to the computing device 104, the data storage 118, or both over the network 116. The server 103 may include hardware components such as a processor 107 and a storage medium 109 that host the AI model 112 or store the training data 110.

The processor 106 of the computing device 104 or the processor 107 of the server 103 may include a central processing unit (CPU), a microprocessor (μP), a microcontroller (μC), a graphics processing unit (GPU), a digital signal processor (DSP), a field-programmable gate array (FPGA), an application-specific integrated circuit (ASIC), or any combination thereof. The processors 106 or 107 may be configured to execute computer instructions that, when executed, cause the processors 106 or 107, the computing device 104, or the server 103 to perform or control performance of one or more of the operations described herein with respect to operation of the robot 102. The processors 106 or 107 may be implemented using a combination of hardware and software. In the present disclosure, operations described as being performed by the processors 106 or 107, the computing device 104, or the server 103 may include operations that the processors 106 or 107, the computing device 104, or the server 103 directs a corresponding system to perform.

The storage mediums 108 or 109 may include a storage medium such as a RAM, persistent or non-volatile storage such as ROM, EEPROM, CD-ROM, or other optical disk storage, magnetic disk storage or other magnetic storage device, NAND flash memory or other solid state storage device, or other persistent or non-volatile computer storage medium. The storage mediums 108 or 109 may store computer instructions that may be executed by the processors 106 or 107, the computing device 104, or the server 103 to perform or control performance of one or more of the operations described herein with respect to operation of the robot 102. In addition, the storage mediums 108 or 109 may store the AI model 112, the training data 110, or both persistently and/or at least temporarily.

The data storage 118 may include any memory or data storage. The data storage 118 may include network communication capabilities such that other components (e.g., 103 or 104) in the environment 100 may communicate with the data storage 118. For example, the computing device 104, the server 103, or both may obtain the AI model 112, the training data 110, or any other appropriate data from the data storage 118. In some embodiments, the data storage 118 may include computer-readable storage media for carrying or having computer-executable instructions or data structures stored thereon. The computer-readable storage media may include any available media that may be accessed by a general-purpose or special-purpose computer, such as a processor. For example, the data storage 118 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 118.

The environment 100 may include a network 116 that includes any communication network configured for communication of signals between any of the components (e.g., 104, 103, or 118) of the environment 100. The network 116 may be wired or wireless. The network 116 may have numerous configurations including a star configuration, a token ring configuration, or another suitable configuration. Furthermore, the network 116 may include a local area network (LAN), a wide area network (WAN) (e.g., the Internet), and/or other interconnected data paths across which multiple devices may communicate. In some embodiments, the network 116 may include a peer-to-peer network. The network 116 may also be coupled to or include portions of a telecommunications network that may enable communication of data in a variety of different communication protocols.

In some embodiments, the network 116 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 116 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the components (e.g., 104, 103, or 118) of the environment 100.

Operations are described in the present disclosure as being performed by the server 103 or the computing device 104 for simplicity of the description. However, the operations may be performed by the server 103, the computing device 104, or both the server 103 and the computing device 104. For example, the AI model 112 may be trained by the server 103 and executed by the computing device 104. As another example, the AI model 112 may be trained by the computing device 104 and executed by the computing device 104. As yet another example, the AI model 112 may be trained and executed by the computing device 104.

As described in more detail below, the AI model 112 may be trained using the training data 110 to identify the tasks the robot 102 is to perform, the series of movements to be made by the robot 102, the series of raw electrical signals to be generated, or some combination thereof.

The training data 110 may include a variety of data types that may be used to train the AI model 112. The training data 110 may include historical data regarding previous tasks that were completed by the robot 102 or other robots. For example, the training data 110 may include data that the computing device 104 generates by monitoring operation of the robot 102 over a period of time, data from the operator of the robot 102, or both. The training data 110 may include raw electrical signals, image data, video data, or sensor data recorded by the computing device 104 while the robot 102 was performing the previous tasks.

The training data 110 may label one or more of the raw electrical signals that correspond to portions of tasks or to entire tasks. For example, the computing device 104 identify one or more particular raw electrical signals that correspond to a previous task and add a label identifying the particular raw electrical signals as corresponding to the previous task. The training data 110 may identify series or sequences of raw electrical signals that correspond to different tasks. In some embodiments, each series or sequence of the raw electrical signals may correspond to a different task. The training data 110 may include labelled datasets that identify specific tasks and the corresponding series or sequence of raw electrical signals. For example, the training data 110 may include a dataset titled “move object” corresponding to the task of moving an object and identifying the series or sequence of raw electrical signals that resulted in moving the object.

The image data or the video data of the training data 110 may be captured by a camera (not shown) of the robot 102. For example, the image data or the video data may include images or videos captured of the environment 100, the robot 102, or items in the environment 100 while the robot 102 performed the previous tasks. In some embodiments, the image data, the video data, or both may be associated with corresponding labelled datasets. For example, the image data captured while the robot 102 was moving the object may be associated with the “move object” dataset.

The sensor data in the training data 110 may include tactile data, force-torque data, voltage levels, current levels, power levels, or any other appropriate type of sensor data related to operation of the actuators 114 while the robot 102 performed the previous tasks. In some embodiments, the sensor data may be associated with corresponding labelled datasets. For example, the sensor data captured while the robot 102 was moving the object may be associated with the “move object” dataset.

The training data 110 may also identify or classify the raw electrical signals as corresponding to the coarse movements or the fine movements of the robot 102. For example, the training data 110 may indicate if a series of raw electrical signals caused the coarse movements of the robot 102 or caused the fine movements of the robot 102. The raw electrical signals may be classified as corresponding to the coarse movements or the fine movements of the robot 102 based signal waveforms of each of the raw electrical signals. For example, the computing device 104 may classify the raw electricals signals based on the amplitude, the frequency (e.g., the rate of providing the raw electrical signals, the signal frequency, or both), the duration value, or some combination thereof of the raw electrical signals.

The training data 110 may include instruction data that may be used to train the AI model 112 to identify tasks based on the instructions. In some embodiments, the instruction data may be organized hierarchically, including high-level instructions that are broken down into multiple tasks or low-level instructions that are associated with individual tasks. The instruction data may include previous instructions that correspond to various tasks or resulted in various tasks being performed by the robot 102. In some embodiments, the training data 110 may include mappings between natural language instructions provided by the operator or machine code instructions provided by the server 103. The instruction data may be associated with corresponding labelled data sets. For example, the instruction provided to cause the robot 102 to move the object may be associated with the “move object” dataset.

In some embodiments, to generate the training data 110, the computing device 104 may monitor the raw electrical signals (e.g., previous raw electrical signals) that are sent to the actuators 114 and cause the robot 102 to move. The computing device 104 may also identify the previous tasks performed by the robot 102 that correspond to the raw electrical signals. For example, the computing device 104 may identify a previous task of rotating a position of the robot 102 corresponds to a particular group of the raw electrical signals. In some embodiments, the computing device 104 may predict, identify, or monitor a signal waveform of each of the raw electrical signals. For example, the computing device 104 may predict, identify, or monitor the amplitude, the frequency, the duration, or some combination thereof of the raw electrical signals. The signal waveforms may include modulated profiles of the raw electrical signals. Additionally, the computing device 104 may predict or identify portions of the previous tasks that correspond to each signal waveform of the raw electrical signals. Accordingly, the computing device 104 may generate the training data 110 such that the training data 110 identifies the raw electrical signals and the tasks for the robot that correspond to the raw electrical signals and the portions of the previous task that correspond to each signal waveform of the raw electrical signals.

In some embodiments, to update the training data 110, the computing device 104 may continue to monitor the raw electrical signals that are sent to the actuators 114 and cause the robot 102 to move. The computing device 104 may continue to identify the tasks for the robot 102 that correspond to the raw electrical signals. Accordingly, the computing device 104 may update the training data 110 based on the continued monitoring

In some embodiments, the processor 107 of the server 103, the processor 106 of the computing device 104, or both may train or update the AI model 112 using the training data 110. The AI model 112 may be trained to extract an intent, requirements, or both of an instruction. Additionally, the AI model 112 may map the intent, the requirements, or both of the instruction to discrete tasks that the robot 102 can perform to complete the operation.

The AI model 112 may be trained using supervised training or other types of reinforced learning techniques. As part of the supervised training, a training portion of the training data 110 may be used to train the AI model 112. A verification portion of the training data 110 may be used to determine if an accuracy of the AI model 112 is greater than a threshold value. If the accuracy exceeds the threshold value, the AI model 112 may be considered to be trained. If the accuracy does not exceed the threshold value, various parameters or settings of the AI model 112 may be adjusted and the AI model 112 may be further trained. Accordingly, the supervised training may allow the AI model 112 to refine the predictions and other outputs over time.

The AI model 112 may be trained to parse and interpret instructions that are provided in natural language, computer code, structured commands, or visual demonstrations. Additionally, the AI model 112 may be trained to predict or identify tasks that correspond to various instructions using the instruction data. Additionally or alternatively, the AI model 112 may be trained to decompose the instructions down into the tasks using the instruction data. In some embodiments, the AI model 112 may be trained to recognize patterns in syntax, semantics, words, or other aspects of the instructions that correspond to different tasks. For example, the AI model 112 may be trained to recognize that an instruction that identifies the robot 102 as the actor and includes the word “position” as corresponding to tasks that involve the robot 102 moving within the environment 100. Tasks that the AI model 112 may be trained to identify may include arm movements, bi-manual movements, navigation tasks, trajectory planning, route planning, interfacing with objects, manipulating objects, or any other appropriate task.

The AI model 112 may be trained to predict or identify the series of movements to be made by the robot 102 to perform the tasks and complete the operations. The AI model 112 may be trained to predict or identify fine movements, coarse movements, or both of the robot 102 to perform the tasks. Additionally, the AI model 112 may be trained to arrange the fine movements or the coarse movements into different stages of the series of movements to be made by the robot 102 to perform the tasks.

The AI model 112 may be trained to predict or identify the series of raw electrical signals (e.g., series of signal waveforms or low level signals) that are to be sent to the actuators 114 to cause the robot 102 to move in accordance with the series of movements and perform the tasks. In other words, the AI model 112 may be trained to predict and/or identify sequences of raw electrical signals that cause the robot 102 to move in a particular manner. The AI model 112 may also be trained to distinguish between the raw electrical signals or the series of raw electrical signals that cause the coarse movements and the fine movements of the robot 102. Thereby, the AI model 112 may cause the computing device 104 to generate and provide the raw electrical signals to activate the actuators 114 and cause the robot 102 to move to perform the tasks and complete the operation.

The movement of the robot 102 may include movement of parts of the robot 102, movements of the entire robot 102, or some combination thereof. For example, the movement of the robot 102 may include moving the robot 102 to position the robot 102 relative to an object, moving a part to adjust a height of the arm 113, or moving the arm 113 to grasp an object. As another example, the movement of the robot 102 may include moving the robot 102 to a first position and then moving the robot 102 to a second position. The parts of the robot 102 may include any part that is used to perform a task. Examples of the parts of the robot 102 include the arm 113, the effector 111, motors (not shown), the wheels 115, a suspension system (not shown), an attachment system (not shown), a conveyor system (not shown), a cargo system (not shown), or any other appropriate part of the robot 102.

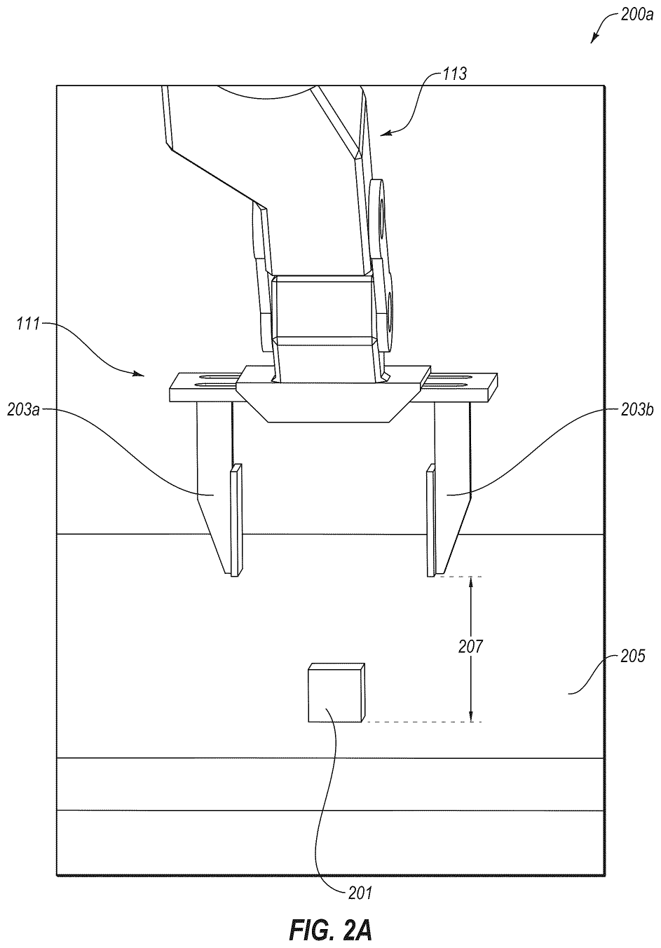

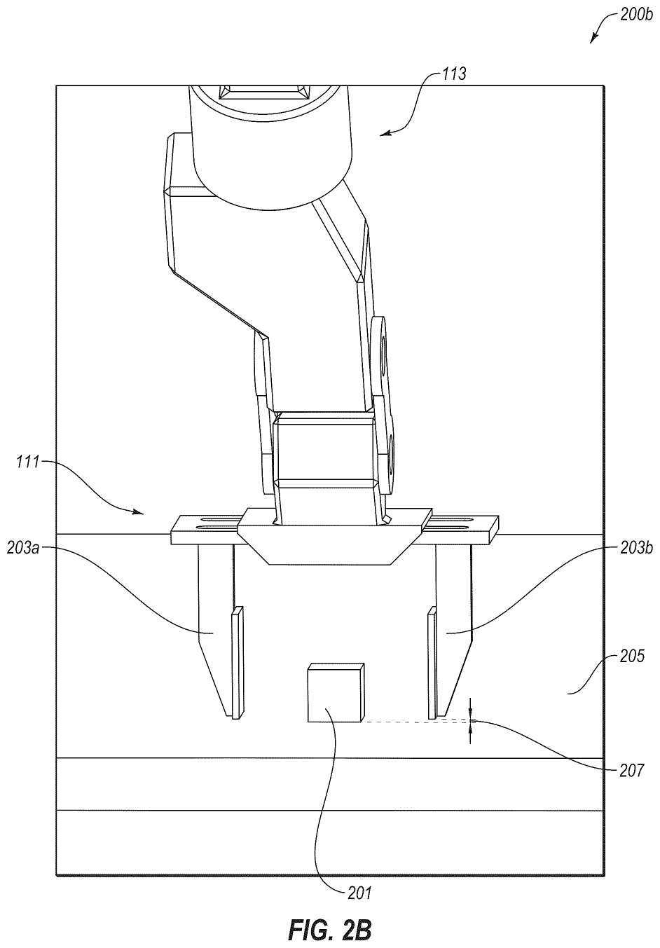

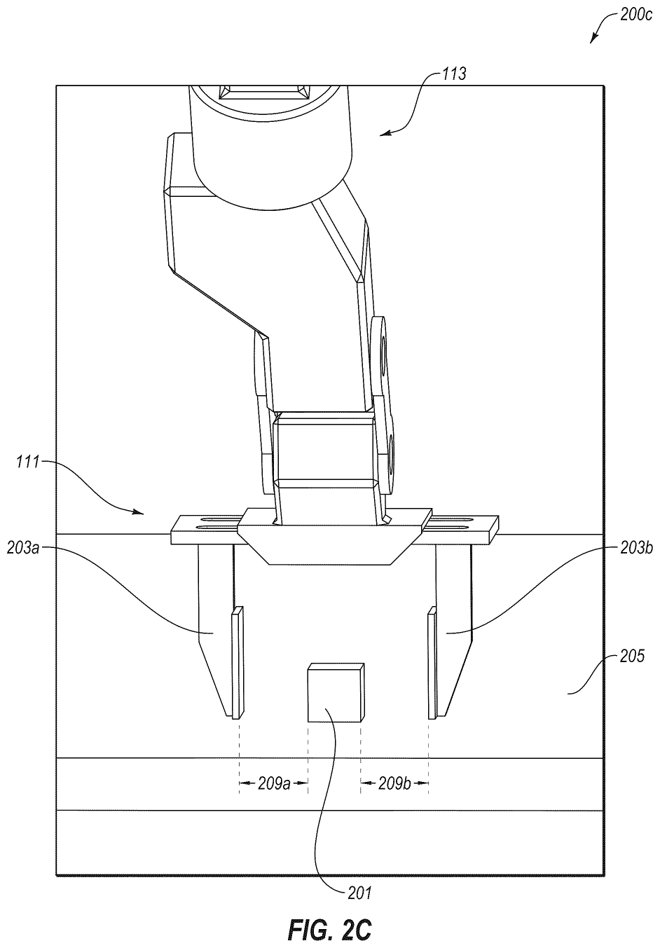

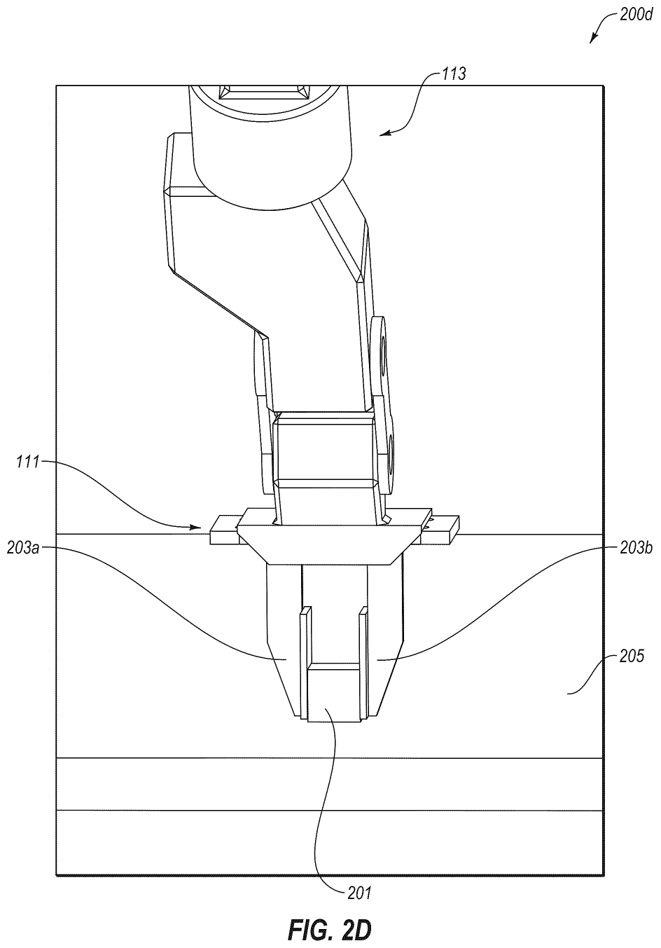

FIGS. 2A-2D illustrate a sequence of views 200a-d of examples of the arm 113 and the effector 111 of the robot 102 of FIG. 1 moving to grasp an object 201, in accordance with at least one embodiment described in the present disclosure. The sequence of views 200a-b shown in FIGS. 2A-2B relate to coarse movements of the arm 113 to position the arm 113 and the effector 111 relative to the object 201. The sequence of views 200c-d shown in FIGS. 2C-2D relate to fine movements of the effector 111 to grasp the object 201.

An example in which the instructions identifying the operation of picking up the object 201 will now be discussed with combined reference to FIGS. 1-2D. The computing device 104 may receive an instruction to “pick up the object 201.” The computing device 104 may execute the AI model 112 to identify a series of tasks to complete the operation (e.g., to pick up the object 201). For example, the AI model 112 may identify the series of tasks including locating the object 201, navigating the robot 102 proximate to the object 201, and grasping the object 201. FIGS. 2A-2D relate to the task of grasping the object 201.

The AI model 112 may identify a series of sub-tasks for the task grasping the object 201. The sub-tasks may include moving the arm 113 to position the object 201 within the effector 111 and moving the effector 111 to grasp the object 201. Additionally, the computing device 104 may execute the AI model 112 to identify a series of movements to be made by the robot 102 to perform the tasks (e.g., movements to position the object 201 within the effector 111 and movements to grasp the object 201). The AI model 112 may arrange the movements into different stages such as a coarse stage and a fine stage. The coarse stage may include movements that correspond to the task of moving the arm 113 to position the object 201 within the effector 111 (e.g., the coarse movements). The fine stage may include movements that correspond to the task of moving the effector 111 to grasp the object 201 (e.g., the fine movements).

The computing device 104 may execute the AI model 112 to predict or identify a series of raw electrical signals to send to the actuators 114 to cause the robot 102 to move in accordance with the series of movements. The AI model 112 may combine the raw electrical signals into different groups that correspond to the different stages of the movements. For example, the AI model 112 may combine the raw electrical signals that correspond to the coarse movements into a first group and combine the raw electrical signals that correspond to the fine movements into a second group. The robot 102 may generate and provide the raw electrical signals to the actuators 114 to cause the robot 102 to perform the task.

To perform the task of moving the arm 113 to position the object 201 within the effector 111, the robot 102 may generate and provide the raw electrical signals to the actuators 114 to cause the arm 113 to move in accordance with the coarse movements. The coarse movements may position the effector 111 closer to a surface 205 that the object 201 is on. For example, the actuators 114 may move the arm 113 such that a length of a space 207 between the effector 111 and the surface 205 at a first point in time (e.g., the first view 200a in FIG. 2A) is greater than the length of the space 207 at a second point in time (e.g., the second view 200b in FIG. 2B).

To perform the task of moving the effector 111 to grasp the object 201, the robot 102 may generate and provide the raw electrical signals to the actuators 114 to cause digits 203a-b of the effector 111 to move in accordance with the fine movements. The fine movements may move the digits 203a-b such that spaces 209a-b between the digits 203a-b and the object 201 are initially reduced at a third point in time (e.g., the third view 200c in FIG. 2C) and subsequently eliminated at a fourth point in time (e.g., the fourth view 200d in FIG. 2D).

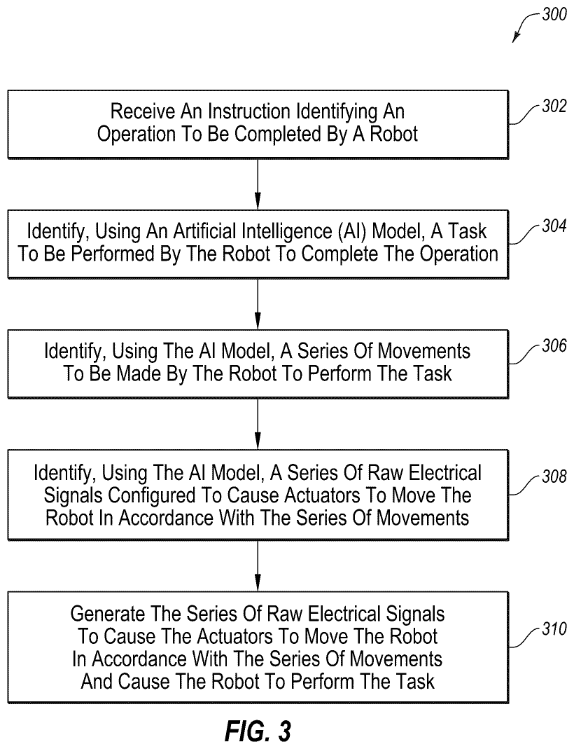

FIG. 3 illustrates a flowchart of an example method 300 to generate raw electrical signals to cause a robot to move, in accordance with at least one embodiment described in the present disclosure. The method 300 may be performed by any suitable system, apparatus, or device with respect to generating the raw electrical signals. For example, the server 103, the computing device 104, or both of FIG. 1 may perform or direct performance of one or more of the operations associated with the method 300. The method 300 may include one or more blocks 302, 304, 306, 308, or 310. Although illustrated with discrete blocks, the steps and operations associated with one or more of the blocks of the method 300 may be divided into additional blocks, combined into fewer blocks, or eliminated, depending on the particular implementation.

At block 302, an instruction identifying an operation to be completed by a robot may be received. For example, the robot 102 of FIG. 1 may receive an instruction from the server 103 or an operator identifying the operation to be completed by the robot 102. At block 304, a task to be performed by the robot to complete the operation may be identified using an AI model. For example, the computing device 104 may execute the AI model 112 to identify a task to be performed by the robot 102 based on the instruction.

At block 306, a series of movements to be made by the robot to perform the task may be identified using the AI model. For example, the computing device 104 may execute the AI model 112 to identify the series of movements to be made by the robot 102 based on the task. At block 308, a series of raw electrical signals configured to cause actuators to move the robot in accordance with the series of movements may be identified using the AI model. For example, the computing device 104 may execute the AI model 112 to identify the series of raw electrical signals configured to cause the actuators 114 to move the robot 102 in accordance with the series of movements.

At block 308, the series of raw electrical signals may be generated to cause the actuators to move the robot in accordance with the series of movements and cause the robot to perform the task. For example, the robot 102, the computing device 104, or both may generate the series of raw electrical signals or cause the raw electrical signals to be generated to cause the actuators 114 to move the robot 102 in accordance with the series of movements and cause the robot 102 to perform the task.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

FIG. 4 illustrates an example computing system 400 that may be used for identifying, generating, or both raw electrical signals for an autonomous robot, in accordance with at least one embodiment of the present disclosure. The computing system 400 may be configured to implement or direct one or more operations associated with autonomous operations of the robot 102 of FIG. 1, which may include operation of the computing device 104, the server 103, the robot 102, or some combination thereof. The computing system 400 may include a processor 402, memory 404, data storage 406, and a communication unit 408, which all may be communicatively coupled. In some embodiments, the computing system 400 may be part of any of the systems or devices described in this disclosure. For example, the computing system 400 may be configured to perform one or more of the tasks described above with respect to the computing device 104, the server 103, the robot 102, or some combination thereof.

The processor 402 may include any computing entity, or processing device including various computer hardware or software modules and may be configured to execute instructions stored on any applicable computer-readable storage media. For example, the processor 402 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 402 may include any number of processors distributed across any number of networks or physical locations that are configured to perform individually or collectively any number of operations described herein.

In some embodiments, the processor 402 may be configured to interpret and/or execute program instructions and/or process data stored in the memory 404, the data storage 406, or the memory 404 and the data storage 406. In some embodiments, the processor 402 may fetch program instructions from the data storage 406 and load the program instructions in the memory 404. After the program instructions are loaded into memory 404, the processor 402 may execute the program instructions.

For example, in some embodiments, the processor 402 may be configured to interpret and/or execute program instructions and/or process data stored in the memory 404, the data storage 406, or the memory 404 and the data storage 406. The program instruction and/or data may be related to an operator directed autonomous system such that the computing system 400 may perform or direct the performance of the operations associated therewith as directed by the instructions.

The memory 404 and the data storage 406 may include computer-readable storage media or one or more computer-readable storage mediums for carrying or having computer-executable instructions or data structures stored thereon. Such computer-readable storage media may be any available media that may be accessed by a computer, such as the processor 402.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 402 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 408 may include any component, device, system, or combination thereof that is configured to transmit or receive information over a network. In some embodiments, the communication unit 408 may communicate with other devices at other locations, the same location, or even other components within the same system. For example, the communication unit 408 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 408 may permit data to be exchanged with a network and/or any other devices or systems described in the present disclosure.

Modifications, additions, or omissions may be made to the computing system 400 without departing from the scope of the present disclosure. For example, in some embodiments, the computing system 400 may include any number of other components that may not be explicitly illustrated or described. Further, depending on certain implementations, the computing system 400 may not include one or more of the components illustrated and described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
receiving an instruction identifying an operation to be completed by a robot;
identifying, using an artificial intelligence (AI) model, a task to be performed by the robot to complete the operation;
identifying, using the AI model, a series of movements to be made by the robot to perform the task;
identifying, using the AI model, a series of raw electrical signals configured to cause actuators to move the robot in accordance with the series of movements; and
generating the series of raw electrical signals to cause the actuators to move the robot in accordance with the series of movements and cause the robot to perform the task.

2. The method of claim 1 comprising:
monitoring previous raw electrical signals that are provided to the actuators to cause the robot to move;
identifying a previous task associated with the previous raw electrical signals; and
generating training data identifying the previous raw electrical signals and the previous task, wherein the AI model is configured to identify the series of raw electrical signals based on the training data.

3. The method of claim 2, wherein the monitoring the previous raw electrical signals comprises monitoring an amplitude, a frequency, or a duration of the previous raw electrical signals.

4. The method of claim 2 comprising training the AI model, using the training data, the AI model to identify the series of raw electrical signals configured to cause the actuators to move the robot in accordance with the series of movements.

5. The method of claim 1, wherein:
the identifying, using the AI model, the series of movements to be made by the robot comprises:
identifying a series of fine movements to be made by the robot; and
identifying a series of coarse movements to be made by the robot; and
the method comprises arranging the fine movements and the coarse movements into different stages of the series of movement to be made by the robot.

6. The method of claim 5 wherein:
the series of raw electrical signals configured to cause the actuators to move the robot in accordance with the series of fine movements comprises generating the raw electrical signals at rate that is equal to or greater than a threshold value; or
the series of raw electrical signals configured to cause the actuators to move the robot in accordance with the series of coarse movements comprises generating the raw electrical signals at a rate that is less than the threshold value.

7. The method of claim 1, wherein each of the raw electrical signals comprises at least one of a pulse width modulation signal, a frequency signal, a voltage signal, or a current signal.

8. A system comprising:
one or more computer readable media configured to store instructions; and
a processor coupled to the computer readable media, the processor configured to execute the instructions to cause or direct the system to perform operations, the operations comprising:
receiving an instruction identifying an operation to be completed by a robot;
identifying, using an artificial intelligence (AI) model, a task to be performed by the robot to complete the operation;
identifying, using the AI model, a series of movements to be made by the robot to perform the task;
identifying, using the AI model, a series of raw electrical signals configured to cause actuators to move the robot in accordance with the series of movements; and
generating the series of raw electrical signals to cause the actuators to move the robot in accordance with the series of movements and cause the robot to perform the task.

9. The system of claim 8, the operations comprising:
monitoring previous raw electrical signals that are provided to the actuators to cause the robot to move;
identifying a previous task associated with the previous raw electrical signals; and
generating training data identifying the previous raw electrical signals and the previous task, wherein the AI model is configured to identify the series of raw electrical signals based on the training data.

10. The system of claim 9, wherein the operation monitoring the previous raw electrical signals comprises monitoring an amplitude, a frequency, or a duration of the previous raw electrical signals.

11. The system of claim 9, the operations comprising training the AI model, using the training data, the AI model to identify the series of raw electrical signals configured to cause the actuators to move the robot in accordance with the series of movements.

12. The system of claim 8, wherein:
the operation identifying, using the AI model, the series of movements to be made by the robot comprises:
identifying a series of fine movements to be made by the robot; and
identifying a series of coarse movements to be made by the robot; and
the operations comprise arranging the fine movements and the coarse movements into different stages of the series of movement to be made by the robot.

13. The system of claim 12, wherein:
the series of raw electrical signals configured to cause the actuators to move the robot in accordance with the series of fine movements comprises generating the raw electrical signals at rate that is equal to or greater than a threshold value equal to or greater than a threshold value; or
the series of raw electrical signals configured to cause the actuators to move the robot in accordance with the series of coarse movements comprises generating the raw electrical signals at a rate that is less than the threshold value.

14. The system of claim 8, wherein each of the raw electrical signals comprises at least one of a pulse width modulation signal, a frequency signal, a voltage signal, or a current signal.

15. A system comprising:
one or more computer readable media configured to store instructions; and
a processor coupled to the computer readable media, the processor configured to execute the instructions to cause or direct the system to perform operations, the operations comprising:
monitoring a plurality of raw electrical signals that are sent to an actuator of a robot, the plurality of raw electrical signals configured to activate the actuator to cause the robot to move;
identifying a task for the robot that corresponds to the plurality of raw electrical signals;
predicting a signal waveform of each raw electrical signal of the plurality of raw electrical signals and a portion of the task for the robot that corresponds to each signal waveform; and
generating training data indicating the task for the robot that corresponds to the plurality of raw electrical signals and the portion of the task for the robot that corresponds to each signal waveform.

16. The system of claim 15, wherein the operations comprise training an artificial intelligence (AI) model using the training data, the AI model being trained to identify a series of raw electrical signals comprising signal waveforms that are to be sent to the actuator to activate the actuator to cause the robot to perform another task.

17. The system of claim 16, wherein the operations comprise:
identifying, using the AI model, another task to be performed by the robot;
identifying, using the AI model, a series of movements to be made by the robot to perform the another task; and
predicting, using the AI model, the raw electrical signals comprising the signal waveforms to that are to be sent to the actuator based on the series of movements.

18. The system of claim 17, wherein
the operation identifying, using the AI model, the series of movements to be made by the robot comprises:
identifying a series of fine movements to be made by the robot; and
identifying a series of coarse movements to be made by the robot; and
the operations comprise arranging the fine movements and the coarse movements into different stages of the series of movement to be made by the robot.

19. The system of claim 15, wherein each signal comprises at least one of a pulse width modulation signal, a frequency signal, a voltage signal, or a current signal.

20. The system of claim 15, wherein the plurality of raw electrical signals comprises a first plurality of raw electrical signals, the task comprises a first task, the operations comprising:
monitoring a second plurality of raw electrical signals that are sent to the actuator of the robot, the second plurality of raw electrical signals configured to activate the actuator to cause the robot to move;
identifying a second task for the robot that corresponds to the second plurality of raw electrical signals;
predicting a signal waveform of each raw electrical signal of the second plurality of raw electrical signals and a portion of the second task for the robot that corresponds to each signal waveform of the second plurality of raw electrical signals; and
updating the training data to indicate the second task for the robot that corresponds to the second plurality of raw electrical signals and the portion of the second task for the robot that corresponds to each signal waveform of the second plurality of raw electrical signals.
